(19) United States
(12) Patent Application Publication
(10) Pub. No.: US 2026/0212306 A1
(43) Pub. Date: Jul. 23, 2026

(54) METHOD AND SYSTEM FOR GENERATING RESOLUTIONS USING KNOWLEDGE GRAPH AND SEMANTIC SIMILARITY

(71) Applicant: Accenture Global Solutions Limited, Dublin (IE)

(72) Inventors: Selvakuberan KARUPPASAMY, Chennai (IN); Ritesh DUBAL, Mumbai (IN); Vinu VARGHESE, Bangalore (IN); Milind Pandurang KHARAT, Mumbai (IN); Sreenivasa Sekhar JOSYULA, Bangalore (IN); Sreevidya PRASAD, Bangalore (IN); Shashank TIWARY, Noida (IN); Arun VISWANATH, Bangalore (IN); Sriram SANKAR, Bangalore (IN)

(73) Assignee: Accenture Global Solutions Limited, Dublin (IE)

(21) Appl. No.: 19/034,205

(22) Filed: Jan. 22, 2025

(51) Int. Cl. G06Q 10/0639; G06F 16/25; G06Q 10/20

(52) U.S. Cl. CPC G06Q 10/06395; G06F 16/254; G06Q 10/06393; G06Q 10/20

(57) ABSTRACT

Method, system, and computer-readable storage media for generating resolutions are disclosed. A knowledge graph representation of various features extracted based on input data including one or more of documents, email communication, and documents stored in one or more databases is generated. Instructor node embeddings and weighted nested domain context corresponding to each of the instructor node embeddings are generated, based upon the knowledge graph representation. A query input including a description of a problem is received from a client device associated with a user. Prior records having semantic similarity with the query input are identified, based on the instructor node embeddings and the weighted nested domain context corresponding to each of the instructor node embeddings. A list of resolutions is generated to solve the problem identified in the query input, based on a respective ranking of each prior record of the prior records.

### TECHNICAL FIELD

Various examples described herein relate generally to method, system, and computer program product for generating resolutions for user reported problems.

### BACKGROUND

Original Equipment Manufacturers (OEMs) design, produce, and/or sell products and/or components that are used in manufacturing of other products. The products and/or the components are often sold under OEMs' brand and are essential for industries such as automotive, electronics, and/or industrial machinery. The OEMs are responsible for ensuring that their products or the components meet quality standards and are durable over time.

Further, for the OEMs, technical repair assistance is a required service that supports the products and/or the components throughout its lifecycle. The technical repair assistance involves providing customers and/or technicians with necessary resources and expertise to troubleshoot, repair, and/or maintain the products. Without the technical repair assistance, breakdowns or malfunctions of the products and/or components may lead to customer dissatisfaction. Therefore, timely and effective technical repair assistance helps the OEMs to maintain reputation of the brand, reduce downtime, and/or ensure the continued functionality of the products and/or the components. Additionally, the technical repair assistance allows the OEMs to manage warranties and post-sale support, optimizing both customer experience and operational efficiency.

### SUMMARY

Implementations of the present disclosure are generally directed to generation of resolutions to problems reported by various users. More particularly, implementations of the present disclosure are directed to identifying and resolving the problems by leveraging knowledge graph representations and Artificial Intelligence (AI) models. Implementations further enable accurate and efficient problem-solving by connecting and analyzing data points, ensuring improved decision-making and fast resolution of the problems.

In at least one example, the present disclosure provides a computer-implemented method for generating resolutions. The method may include generating a knowledge graph representation of a plurality of features extracted based on input data including one or more of a plurality of documents, email communication, and documents stored in one or more databases. The method may further include generating, based upon the knowledge graph representation, a plurality of instructor node embeddings and weighted nested domain context corresponding to each of the plurality of instructor node embeddings. The method may further include receiving, from a client device, associated with a user, a query input. The query input may include a description of a problem. The method may further include identifying, based on the plurality of instructor node embeddings and the weighted nested domain context corresponding to each of the plurality of instructor node embeddings, a plurality of prior records having semantic similarity with the query input. The method may further include generating, based on a respective ranking of each prior record of the plurality of prior records, a list of resolutions to solve the problem identified in the query input.

The present disclosure further describes a system for implementing the method provided herein. The present disclosure also describes a non-transitory computer-readable storage media having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 illustrates an example environment used to execute implementations of the present disclosure.

FIG. 2 illustrates an example architecture of a resolution generation system disclosed in the example environment of FIG. 1, for generating resolutions, in accordance with implementations of the present disclosure.

FIG. 3 illustrates a process flow of generating resolutions, in accordance with implementations of the present disclosure.

FIG. 4 illustrates an example knowledge graph representation related to an automobile, in accordance with implementations of the present disclosure.

FIG. 5 illustrates an example nested instructor node relationship for a vehicle diagnostics or fault detection system, in accordance with implementations of the present disclosure.

FIG. 6 illustrates an example process flow of resolving an issue through a resolution generation system disclosed in the example environment of FIG. 1, in accordance with implementations of the present disclosure.

FIG. 7 is a flow diagram that presents an example computer implemented method for generating resolutions, in accordance with implementations of the present disclosure.

FIG. 8 depicts an example computer system to implement the resolution generation system disclosed in the example environment of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

In today's rapidly evolving technological landscape, industries are increasingly dependent on advanced solutions to provide efficient customer service and operational support. For providing the solutions, technical assistance is required in various sectors including, but not limited to, healthcare, Information Technology (IT), manufacturing, automotive, and/or the like, where complex products, and services require expert troubleshooting and maintenance. Whether in consumer electronics, software, and/or vehicles, providing timely and effective technical assistance is essential for maintaining customer satisfaction and operational continuity.

Existing systems for handling requests for resolving problems face several challenges. The existing systems rely on human intervention to process a large volume of unstructured data, such as emails, documents, and/or prior repair tickets, which results in delays, inefficiencies, and sometimes results in inaccurate solutions, leading to customer dissatisfaction. Furthermore, increase in complexity of products and their customization options strain a process of providing the technical assistance process, escalating operational costs (e.g., related to warranty and post-sale services).

For example, in the automotive sector, large Original Equipment Manufacturers (OEMs) face a challenge that the OEMs receive a massive influx of requests of technical repair and maintenance daily (e.g., up to 3,000 requests per day) across various regions and languages. To handle the requests, the OEMs employ hundreds of Full-Time Employees (FTEs) to manage a Level 1 (L1) technical assistance, offering assistance with repairs, warranties, and product troubleshooting. The L1 technical assistance refers to a first line of assistance provided to customers and/or technicians when the customers and/or technicians encounter an issue with the product. The L1 technical assistance involves basic troubleshooting and problem resolution, often through the technician. An L1 team is responsible for providing the L1 technical assistance. The L1 team handles common and straightforward issues by following predefined scripts and/or guidelines. If the issue is not resolved at L1 level by the L1 team, the issue is escalated to higher levels of support (e.g., level 2 (L2) or level 3 (L3)), where more advanced technical expertise is required. Volume of the requests, and diversity of vehicle models and features add layers of complexity to the technical assistance, often making it a significant operational and financial burden.

Implementations of the present disclosure provide a solution to the above-mentioned challenges by leveraging Artificial Intelligence (AI), particularly knowledge graphs and machine learning embeddings. The solution automates and proactively resolves problems by analyzing historical data, identifying relevant prior records, and generating tailored solutions without requiring extensive human intervention. By automating an assistance process, the solution reduces operational costs, accelerates response times, and enhances overall customer satisfaction, allowing OEMs to efficiently manage complex repair issues across a global scale.

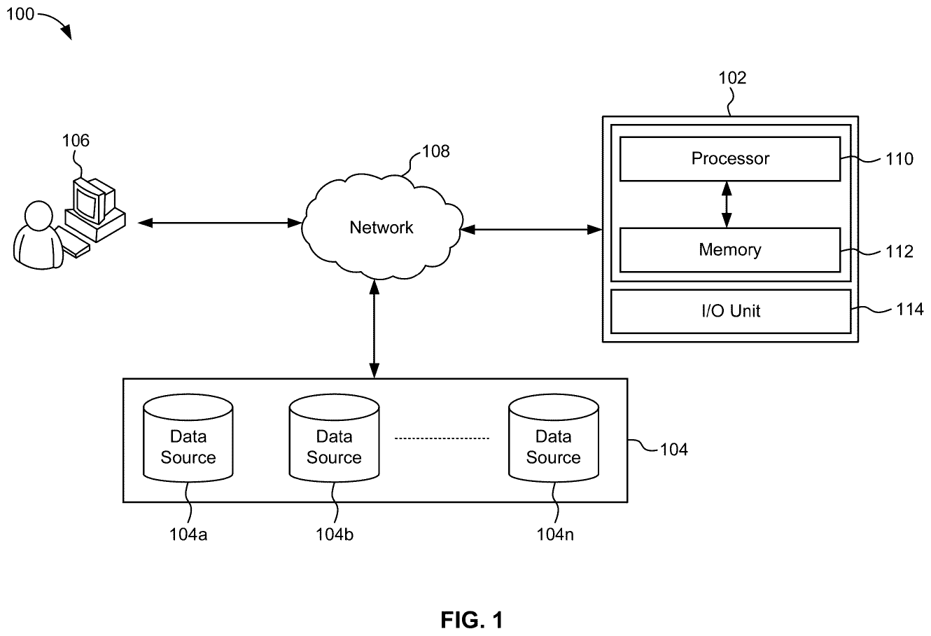

FIG. 1 illustrates an example environment 100 used to execute implementations of the present disclosure. In some examples, the example environment 100 enables generation of resolutions to problems reported by users (e.g., customers) with a product and/or a service. When a user reports a problem, the environment 100 facilitates a provision of a resolution to address the problem.

As depicted in FIG. 1, the example environment 100 includes a resolution generation system 102, data sources 104a-104n, a client device 106, and a network 108. For brevity, only one client device and one resolution generation system are depicted in FIG. 1. However, in some implementations, the environment 100 may include multiple client devices or resolution generation systems. The resolution generation system 102 may interact with the data sources 104a-104n and the client device 106 via the network 108. The network 108 may correspond to a communication network. Examples of the network 108 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. In some examples, the network 108 may be accessed over a wired and/or a wireless communication link.

The data sources may be collectively referenced hereinafter as data sources 104 (also be referenced to as databases). Examples of the data sources 104 may include Onboard Diagnostic Systems (ODS), Customer Relationship Management (CRM) systems, websites, service history databases, monitoring tools, a help desk software, customer support platforms, management systems, and/or the like. The data sources 104 may act as a repository for storing input data. Examples of the input data may include, but are not limited to, documents (e.g., technical manuals, news articles, company reports, and/or the like), e-mail communication, and information such as CRM data, product catalog data, knowledge base or frequently asked questions (FAQs), and/or the like.

The client device 106 is used by the user to log into and interact with computing platforms being provided by the resolution generation system 102. A computing platform may execute applications according to implementations of the present disclosure. The user may be the end-user and/or the customer of the product or the service which has the problem and needs the resolution for the problem. Examples of the client device 106 may include a server, a notebook, a desktop, a netbook, smartphones, laptops, a tablet, and/or voice-enabled devices. It is contemplated that implementations of the present disclosure may be realized with any appropriate type of client device. In some examples, the client device 106 may include a web browser application executed thereon, which may be used to display one or more web pages of the computing platform executing applications. In some examples, the client device 106 may display one or more Graphical User Interfaces (GUIs) that enable the user to interact with the computing platforms.

By way of an example, the user may use the client device 106 to provide a user input to the resolution generation system 102 and receive an output from the resolution generation system 102. The user input may include a query input seeking assistance for a problem or an issue related to the product and/or the service. The output may include the resolution for the problem or the issue.

The resolution generation system 102 may be used to address the query input included in the user input. Examples of the resolution generation system 102 may include, but are not limited to a server, a back-end system, a desktop, a laptop, a notebook, a tablet, a smartphone, a mobile phone, an application server, or the like. In some examples, the resolution generation system 102 may be implemented as an on-premises system that is operated by an organization or a third-party engaged in cross-platform interactions and data management. In some examples, resolution generation system 102 may be implemented as an off-premises system (for example, a cloud or an on-demand system) that is operated by an organization or a third-party on behalf of the organization. In some examples, the resolution generation system 102 may be implemented in a cloud environment. For simplicity, the resolution generation system 102 depicted in FIG. 1 may be a cloud environment that is intended to represent various forms of servers including a web server, an application server, a proxy server, a network server, a server pool, and/or the like.

The resolution generation system 102 includes a processor 110 and a memory 112. In some implementations, the resolution generation system 102 includes more than one processor. The processor 110 may include, for example, microprocessors, microcomputers, microcontrollers, digital signal processors, central processing units, state machines, logic circuits, and/or any devices that manipulate data or signals based on operational instructions. The memory 112 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

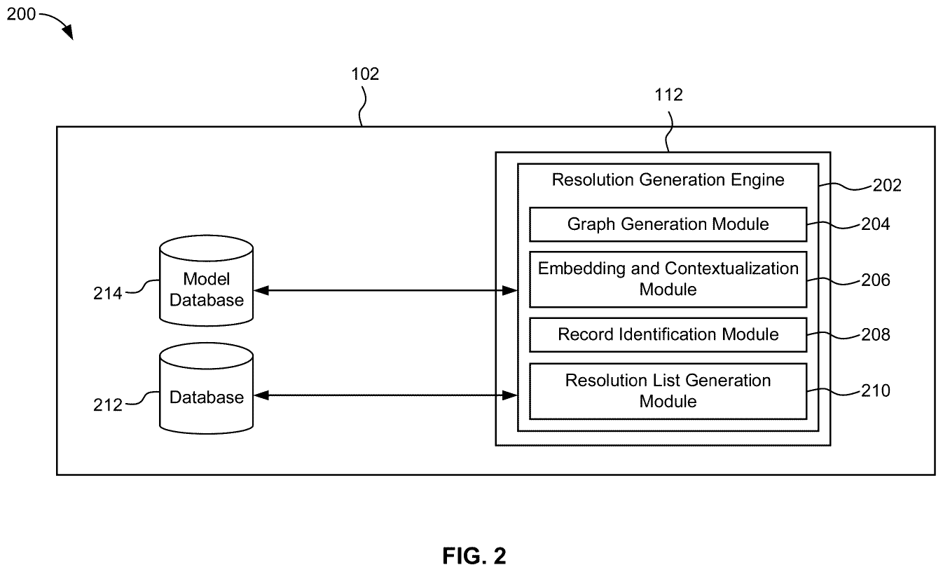

The memory 112 may be communicatively coupled to the processor 110. The memory 112 stores various instructions, which upon execution by the processor 110, cause the processor 110 to perform various operations including knowledge graph generation, embeddings generation, prior record identification, denoising of data, and/or the like. The operations are described further in detail in conjunction with FIG. 2 in the present disclosure. The memory 112 may also store various data (e.g., user inputs, knowledge graph representations, embeddings, various results of analysis, and/or the like) that may be captured, processed, and/or required by the resolution generation system 102. The memory 112 may further include a resolution generation engine (as depicted in FIG. 2) that enable the resolution generation system 102 to generate the resolutions for the problems reported by the users.

The resolution generation system 102 may also include an input/output device (I/O) unit 114. The I/O unit 114 may include a user interface and a display unit (not depicted in FIG. 1). In particular, the resolution generation system 102 may interact with the user via the user interface of the I/O unit 114 accessible via the display of the I/O unit 114. Thus, for example, in some embodiments, the user interface may allow the user to provide the user input for which the resolution needs to be generated. The user input may include the query input that includes seeking assistance to resolve an issue or problem, describing a problem, requesting a solution, and/or similar requests. For example, the user input may be “Can you help me troubleshoot my internet connection?”, “Can you help me troubleshoot my internet connection?”, “Recommend a tool for data analysis?”, “What is the best way to improve fuel efficiency in my car?”, “What should I do if my car overheats while driving?”, or the like.

Once the user input is received through the I/O unit 114, the processor 110 may generate the resolution to address the problem associated with the product and/or the service. The resolution to the address may be generated using the input data stored in the data sources 104. Further, the I/O unit 114 may render the resolution to the user via the client device 106 handled by the user. Various examples of generating the resolution to the address the problem associated with the product and/or the service is described in conjunction with FIGS. 2-8.

FIG. 2 illustrates an example architecture 200 of the resolution generation system 102 disclosed in the example environment of FIG. 1, for generating resolutions, in accordance with implementations of the present disclosure. FIG. 2 is explained in conjunction with FIG. 1. As depicted in FIG. 2, the resolution generation system 102 includes a resolution generation engine 202 within the memory 112. To perform various operations which are required for generating the resolutions, the resolution generation engine 202 may include various modules including a graph generation module 204, an embedding and contextualization module 206, a record identification module 208, and a resolution list generation module 210.

The resolution generation engine 202 may be communicatively coupled to a database 212 for storing various data and/or intermediate results generated by the modules 204-210. The resolution generation engine 202 may store or extract the data from the database 212 as required. The resolution generation engine 202 may also be communicatively coupled to a model database 214 (e.g., via the network 108). The model database 214 may include an Artificial Intelligence (AI) model (not shown in FIG. 2). The modules 204-210 of the resolution generation engine 202 may use the AI model to perform one or more operations.

The graph generation module 204 may receive input data from the one or more of the data sources 104 (depicted in FIG. 1). The input data may include one or more of documents (e.g., service manuals, technical bulletins, vehicle recall notices, maintenance schedules, return/exchange policies, product manuals and/or the like), email communication (e.g., customer support emails, mechanic inquiries, customer feedback, escalation Emails, and/or the like) and records (e.g., product maintenance records, customer support tickets, incident management records, diagnostic Logs, and/or the like). Examples of the data sources 104 may include, but are not limited to, an Onboard Diagnostic System (ODS), a CRM system, a website, a service history database, monitoring tools, a help desk software, a customer support platform, a management system, and/or the like.

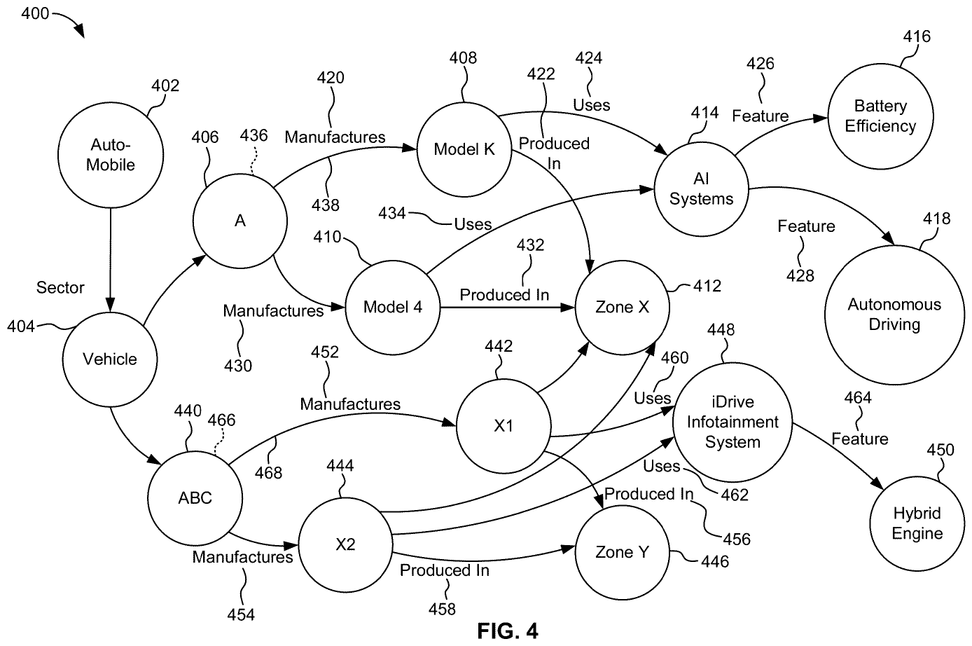

Further, the graph generation module 204 may generate a knowledge graph representation (as illustrated in FIG. 4) of features extracted based on the input data. The graph generation module 204 may use the AI model to generate the knowledge graph representation. The knowledge graph representation may be stored in the database 212, and the database 212 including the knowledge graph representation may act as a graph database.

For generating the knowledge graph, the graph generation module 204 may perform data denoising and formatting of the input data to generate denoised and formatted input data. The data denoising refers to a process of cleaning and removing irrelevant, inaccurate, and/or unnecessary data from the input data to ensure that only useful and meaningful information is utilized further for analysis. The data denoising may improve quality of the input data, so that the input data may be used more effectively in generating the knowledge graph representation. For example, the data denoising may involve removing noise or irrelevant information (e.g., in textual data, unrelated content, such as redundant phrases, or irrelevant comments are removed), filtering outliers, correcting inaccuracies (correcting errors in the input data, such as misspelled words, incorrect values (e.g., an invalid product identity (ID)), or inconsistent formatting), and/or handling missing data. Methods such as imputation may be used to handle the missing data. For example, if the input data includes multiple customer support tickets related to a same problem, the data denoising may help to avoid duplicate entries and select relevant features that may not contribute to the resolution of the problem.

Further, the formatting involves organizing and structuring the input data in a consistent and standardized manner for further processing of the input data for generating the knowledge graph representation. The formatting involves text normalization, structuring unstructured data, converting data types, parsing and categorizing information of the input data, and/or data transformation. Converting a data type of the input data to an appropriate format ensures compatibility of the input data across different systems (e.g., software, databases, applications, or platforms that process, analyze, store, or visualize the data). Normalization of the input data may be performed using techniques such as a min-max scaling, which ensures uniform scaling of the input image. The scaling may refer to a process of adjusting a range of numerical data so that all features or variables in the input data are on a similar scale. For example, in an automotive troubleshooting, the input data may include raw text as “The engine light is on, and the car will not start”. Formatting the input data into a structured format may result in separate fields as “Problem: Engine light on” “Severity: Car will not start” “Vehicle Model: 2018 Fo F-150” “Reported By: XYZ”.

Further, upon performing the data denoising and formatting, the graph generation module 204 may generate or extract insights by deforming and extracting relevant insights from the denoised and formatted input data. The graph generation module 204 may analyze the denoised and formatted input data to find useful patterns, trends, and correlations that provide deeper understanding about problems and solutions reported in the denoised and formatted input data. The insights may be generated by using methods such as natural language processing (NLP) to extract meaningful entities and relationships from the denoised and formatted input data. For example, if the denoised and formatted input data includes multiple support tickets or customer feedback, the insights may include identifying common problems (e.g., “engine overheating”) or frequently mentioned parts (e.g., “fuel pump failure”).

Once the insights are extracted or generated, the graph generation module 204 may extract the features from each sentence of the relevant insights. Each feature of the features represents a combination of an entity (e.g., a part, model, or issue type) of various entities and a respective relationship of the entity with other entities of the various entities. Each entity of the various of entities may represent a feature including one of: a manufacturer, a model, a country, a part or component, or a technology. In other words, the relevant insights that have been extracted from the denoised and formatted data are further broken down into smaller, granular components (e.g., the features). For example, from a sentence such as “The engine light turned on after replacing the fuel pump,” two features may be extracted: (i) Entity: “fuel pump,” Relationship: “replaced,” and (ii) Entity: “engine light,” Relationship: “turned on after” the replacement. Therefore, the feature extraction involves parsing each sentence to identify the entities (e.g., parts, problems, or actions) and the relationships between the entities (e.g., “causes,” “affects,” or “leads to”), thereby the features having the combination of the entities and the relationships may be extracted

The graph generation module 204 may generate multi-level knowledge graphs for each ticket of previous tickets, and each feature of the features. The multi-level knowledge graphs may include multiple knowledge graphs that are visual or computational representations of the entities and the respective relationships. The multi-level knowledge graphs may capture the relationships at different degrees of abstraction or specificity. For example, a simple relationship may link a “vehicle model” to a specific “problem”, while a more complex relationship may include a chain of entities leading from a “part failure” to the “vehicle model”, “issue symptoms”, and finally to “resolved issues”. For each previous ticket, a separate multi-level knowledge graph is generated, capturing the relationships and features within each previous ticket. Over time, the multi-level knowledge graphs may be combined or compared across multiple tickets, enabling the graph generation module 204 to detect the patterns and derive the insights across a larger dataset. Such a multi-level aspect may enable the graph generation module 204 to capture not only direct relationships but also more complex, indirect associations that may help in understanding a root cause of the problem and suggest effective resolutions.

In some implementations, the graph generation module 204 may identify a set of nodes of each of the multi-level knowledge graphs for a set of features of the features. In an example, the set of nodes may include one or more nodes connecting different entities. Alternatively, in another example, the set of nodes may include one or more nodes found responsible for an issue reported in the previous tickets.

The multi-level knowledge graphs may constitute the knowledge graph representation. An example knowledge graph representation is illustrated in FIG. 4.

Referring now to FIG. 4, an example knowledge graph representation 400 related to automobile 402 is illustrated, in accordance with implementations of the present disclosure. As illustrated in FIG. 4, the knowledge graph representation 400 is generated for a category as a vehicle 404. By way of an example, in a first example, consider a scenario, where the input data includes sentences describing operations of a company (e.g., “A, known for electric vehicle technology, manufactures the Model K and Model 4 at a factory located in Zone X. The company uses advanced AI systems to improve battery efficiency and autonomous driving capabilities.”). In such a case, the graph generation module 204 (as illustrated in FIG. 2) may use a feature engineering technique such as Named Entity Recognition (NER), to identify entities within the sentences. For example, an entity “A” 406 is identified as a manufacturer, an entity “Model K” 408 and an entity “Model 4” 410 are identified as vehicle models, an entity “Zone X” 412 is identified as a location, an entity “AI systems” 414 as technology, and entities “battery efficiency 416 and autonomous driving 418” as components or features of vehicles. In addition to identifying the entities, the graph generation module 204, using the NER, may establish relationships between the entities. For example, the graph generation module 204 determines relationships between “A” 406, manufactures 420, “Model K” 408 in (e.g., produced in 422) “Zone X” 412 and uses 424 “AI systems” 414 to improve (e.g., feature 426 and feature 428) “battery efficiency” 416 and “autonomous driving” 418. Similarly, the graph generation module 204 determines relationships between “A” 406, manufactures 430, and “Model 4” 410 in (e.g., produced in 432) “Zone X” 412 and uses 434 “AI systems” 414 to improve (e.g., feature 426 and 428) “battery efficiency” 416 and “autonomous driving” 418. The relationships provide valuable insights into how the entities are connected. The graph generation module 204 may use text embeddings generated by feature engineering techniques such as Word2Vec and/or Bidirectional Encoder Representations from Transformers (BERTs). The text embeddings convert the sentences into a dense vector representation, capturing a semantic meaning of words and phrases in the sentences, including contextual relationships of the words and the phrases. The use of text embeddings allows the graph generation module 204 to determine meaning of terms like “A” 406 and “AI systems” 414 more accurately, even if structure of the sentences is complex or the words have multiple meanings. To handle multiple labels within the sentences (e.g., two models and multiple technologies), multi-label encoding may be used by the graph generation module 204. In the scenario, depicted in FIG. 4, the sentences include multiple vehicle models (e.g., “Model K” 408 and “Model 4” 410). Therefore, each of the vehicle models may be encoded. The multi-label encoding enables handling of multiple entities and respective relationships in a single sentence effectively.

Once the entities and the relationships are identified, the entities and the relationships need to be represented in a format that may be used for further processing, which is achieved by the graph generation module 204 through feature representation techniques. For example, location “Zone X” 412 may be represented using one-hot encoding, where location “Zone X” 412 is transformed into a binary vector that indicates presence of location “Zone X” 412. “A” 406 as a manufacturer may be represented through label encoding, assigning a unique numeric label. The models (“Model K” 408 and “Model 4” 410) are represented using multi-label encoding, while technology such as “AI systems” 414 is encoded as embeddings to capture their meaning. The components “battery efficiency” 416 and “autonomous driving” 418 may be represented using categorical encoding.

Further, the graph generation module 204 may generate the knowledge graph representation 400 to visualize and organize the relationships between the entities. In the knowledge graph representation 400, nodes (e.g., a node 436 corresponding to the entity “A” 406) represent entities like “A” 406, “Model K” 408, “Model 4” 410, “Zone X” 412, “AI systems” 414, “battery efficiency” 416, and “autonomous driving” 418. Edges (e.g., an edge 438 corresponding to the relationship manufactures 420) in the knowledge graph representation 400 represent the relationships, such as “A” 406 manufactures 420 “Model K” 408 and “A” 406 manufactures 430 “Model 4” 410, and/or “A” 406 uses 424, 434 “AI systems” 414 for “battery efficiency” 416 and “autonomous driving” 418. The knowledge graph representation 400 may provide a clear representation of how the entities are interconnected and may be useful in various applications like recommendation systems, search engines, and/or even for further analysis and modelling in AI and machine learning tasks.

By way of another example, in a second example, consider a scenario, where the input data operations of another company that includes sentences: “ABC, a zone Y luxury car manufacturer, produces ABC X1 and ABC X2 at its plant in Zone X The vehicles feature the iDrive infotainment system and a state-of-the-art hybrid engine for improved fuel efficiency”. Similarly, in such a case, the graph generation module 204 may use the feature engineering techniques to identify entities and their relationships in the sentences. The NER is the first technique used to identify the entities within the sentences. For example, an entity “ABC” 440 may be identified as a manufacturer, while entities “X1” 442 and “X2” 444 are identified as the vehicle models. Entities “Zone Y” 446 and “Zone X” 412 are identified as the countries, an entity “iDrive infotainment system” 448 is identified as a technology, and “hybrid engine” 450 is identified as a vehicle component. The NER also helps in establishing the relationships between the entities. For example, the NER identifies relationships that that “ABC” 440 manufactures 452, 454 “X1” 442 and “X2” 444 models in (produced in 456, 458) the “Zone X” 412 and “Zone Y” 446, and that both models “X1” 442 and “X2” 444 of vehicle uses 460, 462 “iDrive infotainment system” 448 and feature 464 “hybrid engine” 450. Further, text embedding techniques, like Word2Vec and/or BERT may be used to represent the entities and technical terms in a vector space. The embeddings capture semantic relationships between words and phrases, which ensures that technical and vehicle-specific terms are interpreted correctly, even in complex sentences and/or when words have multiple meanings.

Further, a label encoding technique may be then used to handle categorical entities such as the manufacturer and the countries. The manufacturer “ABC” 440 may be assigned a unique numeric label, and countries “Zone Y” 446 and “Zone X” 412 are also encoded numerically. For the vehicle models, multi-label encoding may be applied, as both “X1” 442 and “X2” 444 are associated with multiple features, such as being produced in different countries and sharing common technologies. The technology “iDrive infotainment” or “iDrive infotainment system” 448 is encoded as embeddings to capture meaning. The component like “hybrid engine” 450 may also be encoded as distinct features, representing a role in the vehicles. For feature representation, various encoding techniques may be applied. By way of non-limiting example, one-hot encoding may be used for the countries “Zone Y” 446 and “Zone X” 412, where each country may be transformed into a binary vector to indicate presence of each country. The manufacturer “ABC” 440 may be represented through label encoding, assigning “ABC” 440 a unique numeric identifier. The models “X1” 442 and “X2” 444 are handled using multi-label encoding to account for both vehicles being associated with multiple features. The technology and component, such as “iDrive infotainment system” 448 and “hybrid engine” 450, are encoded as features to emphasize roles of the components in enhancing functionality of the vehicle.

Further, the graph generation module 204 may generate the knowledge graph representation 400 to visually represent the relationships between the entities. In the knowledge graph representation 400, nodes (e.g., a node 466 corresponding to the entity “ABC” 440) represent the entities like the manufacturer, vehicle models, countries, technologies, and/or components. The edges (e.g., an edge 468 corresponding to the relationship manufactures 452) define the relationships between the entities, such as “ABC” 440 manufactures 452, 454 “X1” 442 and “X2” 444, the vehicles are manufactured in “Zone X” 412 and “Zone Y” 446, and the vehicles uses technology “iDrive infotainment system” 448 and feature “hybrid engine” 450. By using different methods (e.g. one-hot encoding, multi-label encoding, NER, and the like), diverse types of data present in the sentence are handled efficiently, whether the sentence involves geographic locations, manufacturers, multi-class models, advanced technologies, and/or performance features. Each method complements other methods, allowing for a Comprehensive and detailed representation of the data within the sentence. The above explained examples are summarised as per table (1), given below:

TABLE 1
Entities and Relationships between the entities

| Examples | Entities | Relationships (Knowledge Graph) | Features (Representation) |
|---|---|---|---|
| Vehicle A | Manufacturer: A | A →manufactures → Model K, | Country: One-hot encoded |
| | Models: Model K, | Model 4 | for Zone X |
| | Model 4 | Model K, Model 4 → produced | Manufacturer: Label |
| | Country: Zone X | in → Zone X | encoded for “A” |
| | Technologies: AI | A → uses → AI systems for | Models: Multi-label for |
| | systems | battery efficiency, autonomous | “Model K, Model 4” |
| | Components: | driving | Technology: Embeddings |
| | Battery efficiency, | | for AI systems |
| | autonomous driving | | Components: Battery |
| | | | efficiency, autonomous |
| | | | driving as features |
| ABC | Manufacturer: ABC | ABC → produces → X1, X2 | Countries: One-hot |
| | Models: X1, X2 | X1, X2 produced in | encoded for “Zone Y” and |
| | Countries: Zone Y, | →location Z, Zone Y | “location Z” |
| | Location Z | X1, X2 → feature → iDrive | Manufacturer: Label |
| | Technology: iDrive | infotainment system, hybrid | encoded for “ABC” |
| | infotainment system | engine | Models: Multi-label for |
| | Component: Hybrid | | “X1”, “X2” |
| | engine | | Technology: embeddings |
| | | | for iDrive infotainment |
| | | | system |
| | | | Component: Hybrid |
| | | | Engine as feature |

Referring back to FIG. 2, the graph generation module 204 may be communicatively couped to the embedding and contextualization module 206. In one implementation, the embedding and contextualization module 206 may receive the knowledge graph representation from the graph generation module 204. In an alternative implementation, the embedding and contextualization module 206 may use the knowledge graph representation (generated by the graph generation module 204) stored in the graph database (e.g., the database 212).

The embedding and contextualization module 206 may further generate instructor node embeddings and weighted nested domain context corresponding to each of the instructor node embeddings, based upon the knowledge graph representation. The embedding and contextualization module 206 may use the AI model to generate the instructor node embeddings and weighted nested domain context.

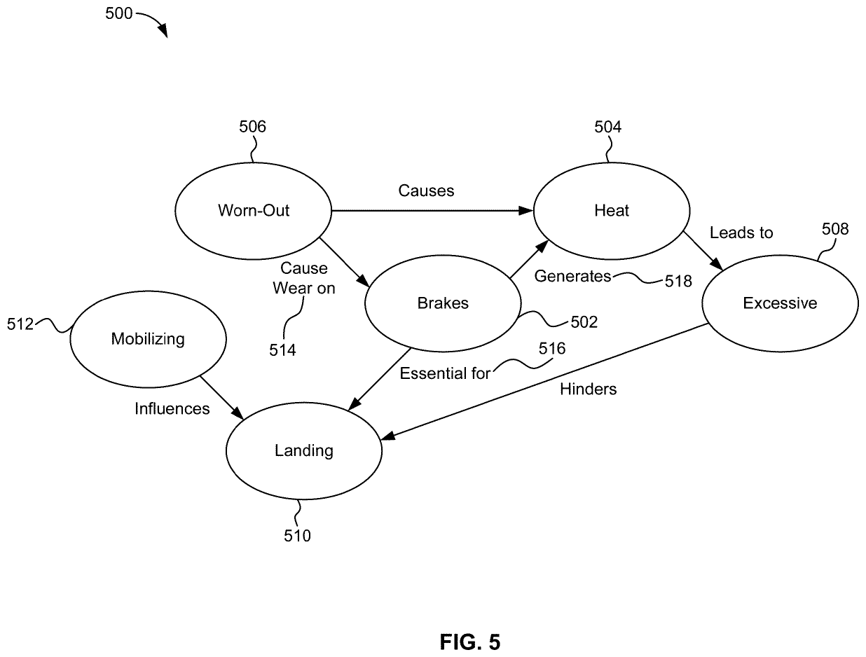

In an implementation, to generate the weighted nested domain context, the embedding and contextualization module 206 may aggregate the set of nodes of the multi-level knowledge graph of the multi-level knowledge graphs to generate a set of instructor nodes. The set of nodes may be identified by the graph generation module 204 for the set of features extracted from the relevant insights (as descried above along with the graph generation module 204). The set of nodes are common across the features. Further, the embedding and contextualization module 206 may construct a nested instructor node relationship across the features corresponding to the set of nodes (as illustrated in FIG. 5). Once the nested instructor node relationship is constructed, the embedding and contextualization module 206 may compute a nested instructor node relationship score (NIRS) for the constructed nested instructor node relationship. Furthermore, the embedding and contextualization module 206 may apply the nested instructor node relationship score as a weighted nested instructor score to all nodes of the set of instructor nodes.

In detail, the embedding and contextualization module 206 may receive an input including the features, the entities, the set of nodes identified for the set of features, the knowledge graph representation, and the relationships between the entities. In an implementation, the embedding and contextualization module 206 may perform entity normalization, which includes generation of the weighted nested domain context from the knowledge graph representation for each feature, ensuring that the relationships of a particular entity may be linked to other entities. The weighted nested domain context represents properties and relationships for a group of entities and a nested instructor node relationship that is common to specific entities. The nested instructor node relationship may also be constructed from the knowledge graph representation, which ensures that the relationships are effectively normalized, making the relationships suitable for accurate predictions and contextual understanding.

The embedding and contextualization module 206 may capture how relationships within a particular entity may be linked to other entities, allowing for a deeper analysis of the interdependencies. First properties and relationships for a group of entities may be represented and then the nested instructor node relationship may be constructed that is specific to particular entities. By constructing the nested instructor node relationship, it may be ensured that relationships between the entities are accurately represented and effectively utilized. For each of the features, instructor nodes are identified. The instructor nodes are identified based on their importance, such as nodes connected to multiple entities or nodes that play a significant role in a particular application where the resolution generation system 102 is employed. For example, “worn-out brakes” may be an instructor node, which is linked to potential issues like “damage” or “excessive heat”. Consider that N1, N2, N3 . . . . Nn, represent the instructor nodes for each feature. Nested instructor node relationships are generated by aggregating the instructor nodes that are common across different features. The aggregation captures how certain the instructor nodes relate to multiple aspects, facilitating a comprehensive understanding of the connections. The nested instructor node relationships are constructed across the features, and for each of the nested instructor node relationships, the NIRS is computed based on properties and effects associated with nodes. The NIRS is computed as per equation (1), given below:

$$NIRS = \frac{\sum ( N 1 \times E 1 \times F 1 + N 2 \times E 2 \times F 2 + … + Nn \times Fn )}{log \{ ( ( N 1 \times E 1 \times F 1 + N 2 \times E 2 \times F 2 + … + Nn \times Fn ) ) \}} \qquad equation ( 1 )$$

Where: “N” represents number of nodes, “E” represents number of edges (or connections), “F” represents features. Once the NIRS is computed for each of the instructor nodes, weights are applied to each relationship to adjust for varying significance of connections. A final weighted NIRS is then determined, with the nodes receiving highest scores aggregating context for the entire system or text associated with the application of the resolution generation system 102. The construction of the nested instructor node relationships is illustrated with an example in FIG. 5.

Referring now to FIG. 5, an example nested instructor node relationship 500 for a vehicle diagnostics or fault detection system is illustrated, in accordance with implementations of the present disclosure. The nested instructor node relationship 500 includes various nodes representing entities such as ‘brakes’ 502, ‘heat’ 504, ‘worn-out’ 506, ‘excessive’ 508, ‘landing’ 510, ‘mobilizing’ 512. The embedding and contextualization module 206 (as illustrated in FIG. 2) may model interdependencies between the entities and how the entities interact with other entities in the knowledge graph representation. Further, in the vehicle diagnostics system, a node corresponding to the entity ‘brakes’ 502 may be identified as an instructor node because of an important role in safety and the potential impact on vehicle functionality. Other entities 504-512 related to the entity ‘brakes’ 502 may be linked, forming a network of relationships. For example, a node corresponding to the ‘brakes’ 502 may be connected to other nodes corresponding to the entities ‘worn-out’ 506, ‘landing’ 510, and ‘heat’ 504, each with distinct relationships, such as ‘worn-out’ 506→ ‘brakes’ 502 (cause ‘wear on’ 514), ‘brakes’ 502→ ‘landing’ 510 (essential for 516), and ‘brakes’ 502→ ‘heat’ 504 (‘generates’ 518). The relationships form a basis for generating the nested instructor node relationship 500, where context of each node is analysed in relation to other nodes. To generate the nested instructor node relationship 500, FIG. 5 captures how the instructor node is connected and interacts with other nodes. The relationships are then categorized and scored based on importance. For example, the relationship between the entities ‘brakes’ 502 and ‘worn-out’ 506 (where “worn-out” causes wear on “brakes”) is one of many potential connections. Similarly, the ‘brakes’ 502 also connects to ‘landing’ 510 and ‘heat’ 504, reflecting importance in vehicle operation. Each relationship adds context to overall vehicle diagnostics or fault detection system, generating the nested instructor node relationship. The nested instructor node relationship 500 provide a structure that represents how different entities are interlinked and potential impact each node has on other nodes. Relationships between the nodes are represented through an adjacency matrix, which is used to show connections between the nodes in a mathematical format, as given below in table (2):

TABLE 2
Adjacency matrix depicting connections between the
nodes or entities

| Nodes | Worn-out | brakes | landing | heat | excessive | mobilizing |
|---|---|---|---|---|---|---|
| Worn-out | 0 | 1 | 0 | 1 | 0 | 0 |
| Brakes | 0 | 0 | 1 | 1 | 0 | 0 |
| landing | 0 | 0 | 0 | 0 | 0 | 0 |
| Heat | 0 | 0 | 0 | 0 | 1 | 0 |
| excessive | 0 | 0 | 1 | 0 | 0 | 0 |
| mobilizing | 0 | 0 | 1 | 0 | 0 | 0 |

In the adjacency matrix depicted in table (2), each node corresponds to both a row and a column, with matrix cells indicating the relationships (e.g., edges) between the nodes. The adjacency matrix of table (2) allows for a clear representation of complex relationships between the nodes and provides the foundation for further analysis, such as calculating node importance or determining fault patterns. For the node corresponding to the entity ‘breaks’ 502, embedding calculation may be performed by assessing in-degree and out-degree of the node corresponding to the entity ‘breaks’ 502. The in-degree refers to a number of relationships pointing towards the node, while the out-degree refers to a number of relationships emanating from the node. In this case of the node corresponding to the entity ‘brakes’ 502, there exists an incoming relationship (“worn-out→brakes”), so the in-degree is “1”. The out-degree is “2”, as the entity ‘brakes’ 502 connects to both the entities ‘landing’ 510 (‘essential’ for 516) and ‘heat’ 504 (‘generates’ 518). Therefore, the node corresponding to the entity ‘brakes’ 502 has a total of 3 connections, which are used to calculate a final instructor node embedding of the entity ‘breaks’ 502. The final instructor node embedding for each instructor node reflects context of the instructor node and relationships of the instructor node with other nodes. The final instructor node embeddings are important for downstream tasks such as classification, similarity analysis, or fault prediction. The NIRS are weighted based on the number of connections the node has. More connections a node corresponding to the entity ‘brakes’ 502 has, the more significant the node becomes. The weighted NIRS may aid in identifying which nodes are most critical for understanding behaviour of the vehicle diagnostics or fault detection system. The generation of the nested instructor node relationship 500 and the final instructor node embeddings enable a deeper understanding of how individual entity, like ‘brakes’ 502, interact within the vehicle diagnostics or fault detection system.

Further, referring back to FIG. 2, in an implementation, a query input may be received from a user by the resolution generation engine 202 through the I/O unit 114 (depicted in FIG. 1). The query input may include a description of a problem or a new ticket seeking assistance for the problem. For example, the query input may be “The check engine light is on, and my car makes a strange noise when I accelerate”. Upon receiving the query input, the record identification module 208 may identify prior records having semantic similarity with the query input, based on the instructor node embeddings and the weighted nested domain context corresponding to each of the instructor node embeddings. Further, the resolution list generation module 210 may generate a list of resolutions to solve the problem identified in the query input based on a respective ranking of each prior record of the prior records. The list of resolutions has the respective ranking of each prior record of the prior records that exceeds a specified threshold value.

In detail, the record identification module 208 may gather data, which includes various components. The data includes the multi-level knowledge graph representation (e.g., a nested profiling knowledge graph), which represents structure of knowledge and relationships between different entities. The knowledge graph provides a foundational context for understanding the connections between various components and helps to map the relationships between different entities. Alongside the knowledge graph representation, the gathered data may also include the NIRS. The NIRS reflects the relevance and importance of individual entities within the knowledge graph representation, factoring in their relationships and context in which the entities appear. In addition, the gathered data may include the context of the entities that refer to surrounding details and circumstances of the entities within a system, including historical data and any specific attributes that help to define roles or behavior of the entities within a broader context. Together, the gathered data may provide a foundation for determining problems from the query input and facilitate the accurate processing of the query input by resolving tickets or queries associated with the query input.

Once the data has been gathered, the record identification module 208 may convert the data into a format that may be easily processed using the AI model. By way of non-limiting example, in case of the data including the knowledge graph representation, a nested vectorizer technique may be used to encode the nodes within the knowledge graph representation. As a result, not only intrinsic properties of each node but also relationships that each node has with other entities may be captured. The relationships are important because the relationships provide context that aids in determining a true meaning of each node. Further, the record identification module 208 may use an encoder (not shown in FIG. 2) may be used to process the data, and the resulting encoded data is stored for later use. Additionally, the record identification module 208 may integrate unstructured text embeddings, derived from textual data (such as ticket descriptions or previous queries) using NLP models. The embeddings, which are generated through the NLP models, provide a numerical representation of the semantic meaning of text, enabling the record identification module 208 to determine underlying concepts and relationships in the data. The embeddings from both the encoded nodes and the unstructured text are stored and serve as the basis for the next steps.

Further, a semantic search may be performed, where the record identification module 208 may compare embeddings of the query input or the new ticket in the query input against historical tickets (e.g., historical data) relevant for the query input stored in the database 212. By comparison, tickets with a high degree of similarity among the historical tickets to the new ticket may be identified, so that solutions to past problems may be applied to the problem associated with the query input or the new tickets. A similarity between the embeddings of the new ticket and the historical tickets ensures that only tickets with a high similarity score are considered. Based on the similarity, the resolution list generation module 210 may perform filtering. The filtering ensures that irrelevant or unrelated historical data is excluded from further consideration. After determining the similarity tickets that fall below a specified threshold value may be discarded. The specified threshold value may change in each iteration to an increasing scale and may be selected based on robustness and incremental learning of the resolution generation system 102. From remaining historical tickets, top “x” (e.g., 2, 3, 4, 10, 100, and/or the like) closest matches are selected, and respective scores are maintained. The top “x” results represent the most relevant past tickets that may provide valuable insights for resolving the current problem associated with the query input.

The relevant historical tickets are used to generate resolutions for the current ticket. Context and content of the most relevant historical tickets may be assessed, and corresponding resolutions may be applied to the new ticket. A final output is the most applicable resolution for the ticket, or the query input raised, based on insights drawn from the historical data. The resolution may be provided to the client device 106 through the I/O unit 114 (depicted in FIG. 1) as an output for the received query input.

In some implementations, the resolution generation system 102 continuously learns from new scenarios. For example, with each new ticket or problem, the resolution generation system 102 refines the generated resolutions and improves its ability to generate accurate resolutions. Over time, the resolution generation system 102 becomes more adept at handling a wider variety of problems. Additionally, the resolution generation system 102 is capable of detecting new problems that have not been encountered in past. By analyzing historical data and identifying patterns, the resolution generation system 102 may identify emerging problems that fall outside of previously encountered scenarios, allowing the resolution generation system 102 to adapt and provide solutions for completely new types of problems.

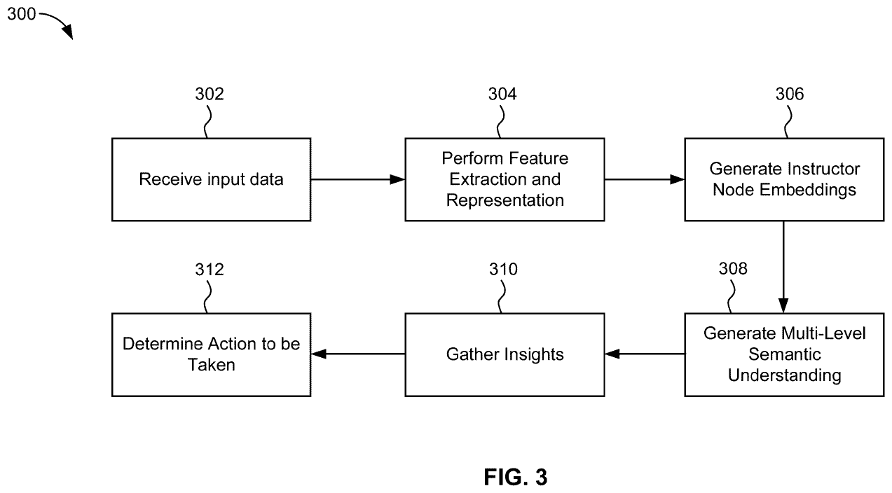

FIG. 3 illustrates a process flow 300 of generating resolutions, in accordance with implementations of the present disclosure. FIG. 3 is explained in conjunction with FIGS. 1-2.

The process flow 300 includes receiving 302 input data, where raw data from diverse sources, including technical manuals and mail chains is gathered. The input data is unstructured data. The process flow 300 further includes performing 304 feature extraction and representation, where the input data is first cleaned through data denoising and formatting to remove irrelevant information. Then, text within the input data is broken down through sentence-level deformation and entities (e.g., people, tools) are identified. Additionally, relationships and events involving the entities are extracted, and the input data is structured into a knowledge graph representation to visualize and analyze interactions among the entities. This is already explained in detail in conjunction with graph generation module 204 of FIG. 2.

The process flow 300 further includes generating 306 instructor node embeddings, where instructor nodes and understanding relationships of the instructor nodes is identified. The instructor node embeddings help to establish the connections and weighted nested domain context, prioritizing relevant interactions, which has been already explained in detail in conjunction with embedding and contextualization module 206. The process flow 300 further includes generating 308 multi-level semantic understanding, where multi-level embeddings are generated at the instructor node level, supporting tasks like semantic search and the retrieval of similar tickets or historical cases. The multi-level semantic understanding ensures that new issues are indexed and compared to historical data for faster problem-solving. The process flow includes gathering 310 insights (e.g., entity relationships, semantic analysis, and historical data). Further, the process flow 300 includes determining 312 an action to be taken (e.g., an issue resolution, escalation, a follow-up action, and/or the like) and proceeds with closure, ensuring that the resolution is implemented and documented for future reference.

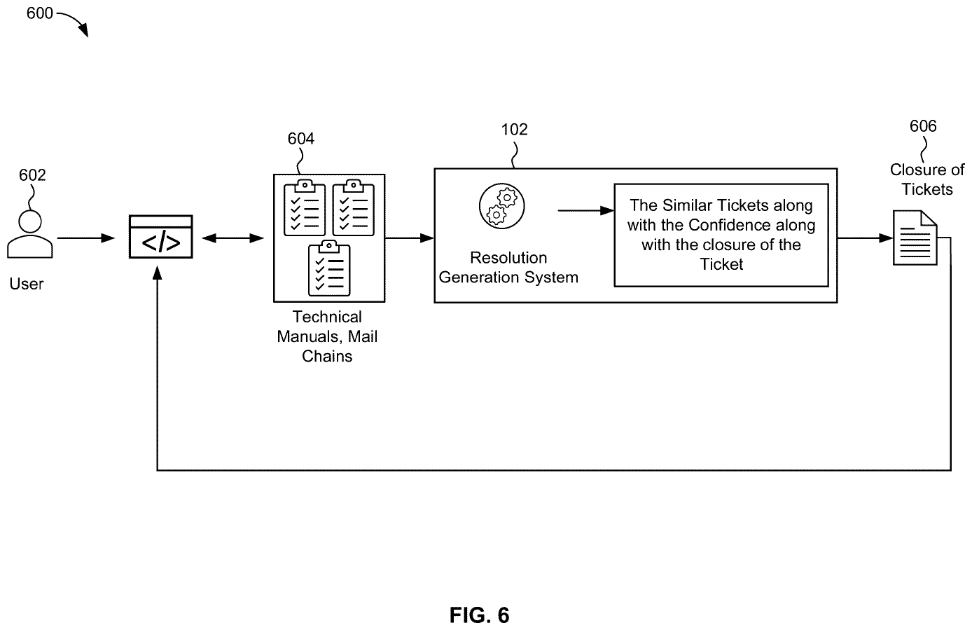

FIG. 6 illustrates an example process flow 600 of resolving an issue through the resolution generation system 102, in accordance with implementations of the present disclosure. FIG. 6 is explained in conjunction with FIGS. 1-5. The process flow 600 includes receiving a ticket from a user 602 (through the client device 106 as depicted in FIG. 1) relate to the issue by the resolution generation system 102. The issue may be a technical issue, a request, and/or problem. The resolution generation system 102 may be trained based on input data from various data sources as explained in FIG. 2. The input data may include technical manuals and mail chains 604.

Once the ticket is received, the resolution generation system 102 may provide solutions to the ticket based on common issues, troubleshooting steps, and/or past interactions related to similar tickets. The resolution generation system 102 may assess relevance and confidence level of resolutions, ranking the resolutions based on factors like past success rates and similarity to the current issue. The generated resolutions are then presented to the user 602 for further evaluation. As the resolution generation system 102 processes the ticket, the resolution generation system 102 also identifies similar tickets from a knowledge graph. The similar tickets are tickets that have resolved similar problems in past. The resolution generation system 102 provides the similar tickets along with a confidence score, which reflects how closely past resolutions match the current ticket. The confidence score helps the user to assess potential effectiveness of suggested solution. High confidence score indicates that the recommended solution is likely to resolve the issue. Finally, once the resolution is applied and confirmed, the process flow 600 proceeds to closure 606 of the ticket. Closure 606 of the ticket confirms that the issue has been fully addressed and that the user is satisfied with the solution. Once the ticket is closed, the resolution generation system 102 updates the knowledge graph, ensuring that any new insights or solutions are recorded for future reference. The resolution generation system 102 continuously learns and improves from the past or historical tickets, making it more efficient in resolving future issues.

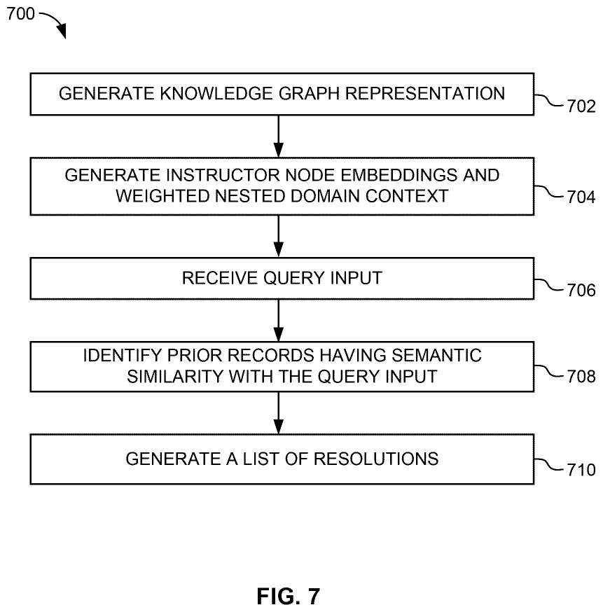

FIG. 7 is a flow diagram that presents an example computer implemented method 700 for generating resolutions, in accordance with implementations of the present disclosure. In some implementations, the computer implemented method 700 may be executed by the resolution generation system 102, as described in relation to FIG. 1.

The computer implemented method 700 may include generating 702 a knowledge graph representation of various features extracted based on input data including one or more of documents, email communication, and documents stored in one or more databases. In an implementation, to generate 702 the knowledge graph representation, data denoising and formatting of the input data may be performed to generate denoised and formatted input data. Upon performing the data denoising and formatting, insights may be generated or extracted by deforming and extracting relevant insights from the denoised and formatted input data. Further, features may be extracted from each sentence of the relevant insights. Each feature of the features represents a combination of an entity of various entities and a respective relationship of the entity with other entities of the various entities. Each entity of the various entities represents a feature including one of: a manufacturer, a model, a country, a part or component, or a technology. Furthermore, multi-level knowledge graphs may be generated for each feature of the features and each ticket of previous tickets.

In some implementations, a set of nodes of a multi-level knowledge graph of the multi-level knowledge graphs may be identified, for a set of features of the features. In an example, the set of nodes may include one or more nodes connecting different entities. Alternatively, in another example, the set of nodes may include one or more nodes found responsible for an issue reported in the previous tickets. The generation 702 of the knowledge graph representation is already explained in detail in conjunction with the graph generation module 204 in FIG. 2.

The computer implemented method 700 may further include generating 704 instructor node embeddings and weighted nested domain context corresponding to each of the instructor node embeddings. In some implementations, to generate the weighted nested domain context corresponding to each of the instructor node embeddings, nodes of a multi-level knowledge graph of the multi-level knowledge graphs may be aggregated to generate a set of instructor nodes. The nodes may be common across the features. Thereafter, a nested instructor node relationship across the features may be constructed. Further, a nested instructor node relationship score may be computed for the constructed nested instructor node relationship. The nested instructor node relationship score may be applied as a weighted nested instructor score to all nodes of the set of instructor nodes. The generation 704 of the instructor node embeddings and the weighted nested domain context is already explained in detail in conjunction with the embedding and contextualization module 206 in FIG. 2.

The computer implemented method 700 may further include receiving 706 a query input from a client device (e.g., the client device 106 depicted in FIG. 1) associated with a user. The query input may include a description of a problem, which has already been explained in detail in FIG. 2. The computer implemented method 700 may further include identifying 708 prior records having semantic similarity with the query input based on the instructor node embeddings and the weighted nested domain context corresponding to each of the instructor node embeddings. The identification 708 of the prior records is already explained in detail in conjunction with the record identification module 208 in FIG. 2.

The computer implemented method 700 may further include generating 710 a list of resolutions to solve the problem identified in the query input, based on a respective ranking of each prior record of the plurality of prior records. In some implementations, the list of resolutions having the respective ranking of each prior record of the prior records that exceeds a specified threshold value may be generated. The generation 710 of the list of resolutions is already explained in detail in conjunction with the resolution list generation module 210 in FIG. 2.

Implementations of the present disclosure enable an efficient and automated solution for providing resolutions by leveraging an AI model. Implementations involve processing large volumes of unstructured data, such as documents, emails, and database entries, to identify relevant past cases and provide proactive resolutions. By generating a knowledge graph representation of features extracted from the input data and utilizing instructor node embeddings with weighted nested domain context, the implementations may accurately match new queries with prior records, ranking potential resolutions based on semantic similarity. Implementations provide an ability to drastically reduce the need for large-scale human intervention, automate level 1 support for complex requests, and enhance response accuracy, ultimately lowering costs and utilization of computing resources, improving customer satisfaction, and minimizing downtime. Additionally, implementations of the present disclosure are scalable and adaptive, allowing the resolution generation system 102 to evolve and identify emerging issues even before the issues occur, offering a significant competitive edge to automotive OEMs.

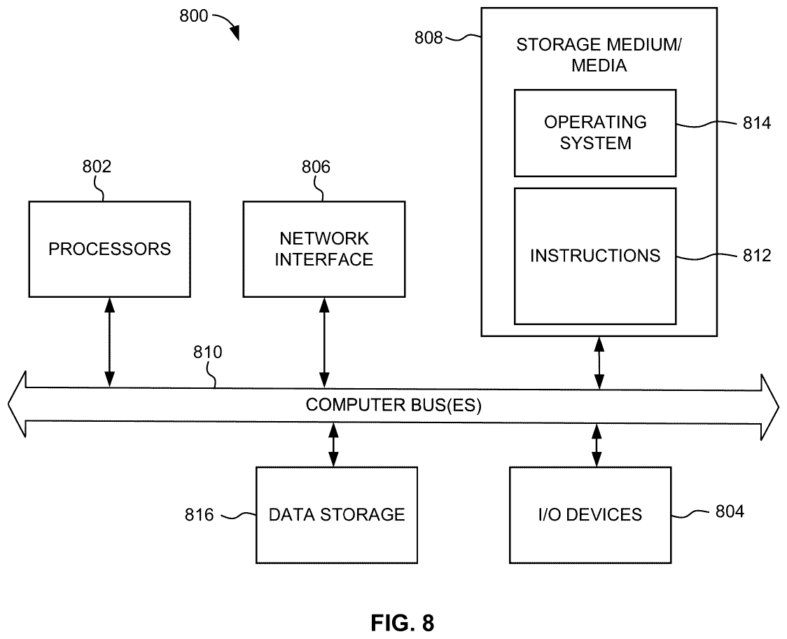

FIG. 8 depicts a computer system 800 that may be used to implement the resolution generation system 102. More particularly, computing machines such as desktops, laptops, smartphones, tablets, and wearables which may be used to generate resolutions to problems associated with a product or a service and reported by users. The computer system 800 may include additional components not shown and that some of the process components described may be removed and/or modified. In another example, the computer system 800 may be deployed on external-cloud platforms such as cloud, internal corporate cloud computing clusters, organizational computing resources, and/or the like.

The computer system 800 includes processor(s) 802, such as a central processing unit, an application specific integrated circuit (ASIC) or another type of processing circuit, input/output devices 804, such as a display, mouse keyboard, etc., a network interface 806, such as a Local Area Network (LAN), a wireless 802.11x LAN, a 3G or 4G mobile WAN or a WiMax WAN, and a storage medium/media 808. Each of these components may be operatively coupled to a computer bus 810. The storage medium/media 808 may be any suitable medium that participates in providing instructions to the processor(s) 802 for execution. For example, the storage medium/media 808 may be non-transitory or non-volatile medium, such as a magnetic disk or solid-state non-volatile memory or volatile medium such as RAM. The instructions or modules stored on the storage medium/media 808 may include machine-readable instructions 812 executed by the processor(s) 802 that cause the processor(s) 802 to perform the methods and functions of the resolution generation system 102.

The resolution generation system 102 may be implemented as software stored on a non-transitory processor-readable medium and executed by the processor(s) 802. For example, the storage medium/media 808 may store an operating system 814, such as MAC OS, MS WINDOWS, UNIX, or LINUX, and code, for the resolution generation system 102. The operating system 814 may be multi-user, multiprocessing, multitasking, multithreading, real-time, and the like. For example, during runtime, the operating system 814 is running and the code for the resolution generation system 102 is executed by the processor(s) 802.

The computer system 800 may include a data storage 816, which may include non-volatile data storage. The data storage 816 stores any data used or generated by the resolution generation system 102.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
generating a knowledge graph representation of a plurality of features extracted based on input data comprising one or more of a plurality of documents, email communication, and records stored in one or more data sources;
generating, based upon the knowledge graph representation, a plurality of instructor node embeddings and weighted nested domain context corresponding to each of the plurality of instructor node embeddings;
receiving, from a client device associated with a user, a query input, wherein the query input comprises a description of a problem;
identifying, based on the plurality of instructor node embeddings and the weighted nested domain context corresponding to each of the plurality of instructor node embeddings, a plurality of prior records having semantic similarity with the query input; and
generating, based on a respective ranking of each prior record of the plurality of prior records, a list of resolutions to solve the problem identified in the query input.

2. The computer-implemented method of claim 1, wherein the generating the knowledge graph comprises:
performing data denoising and formatting of the input data to generate denoised and formatted input data;
generating or extracting, upon performing the data denoising and formatting, insights by deforming and extracting relevant insights from the denoised and formatted input data;
extracting, from each sentence of the relevant insights, a plurality of features, wherein each feature of the plurality of features represents a combination of an entity of a plurality of entities and a respective relationship of the entity with other entities of the plurality of entities; and
generating, for each feature of the plurality of features, a plurality of multi-level knowledge graphs for each ticket of a plurality of previous tickets.

3. The computer-implemented method of claim 2, wherein each entity of the plurality of entities represents a feature comprising one of: a manufacturer, a model, a country, a part or component, or a technology.

4. The computer-implemented method of claim 2, further comprising identifying, for a set of features of the plurality of features, a set of nodes of a multi-level knowledge graph of the plurality of multi-level knowledge graphs, wherein the set of nodes comprises one or more nodes connecting different entities.

5. The computer-implemented method of claim 2, further comprising identifying, for a set of features of the plurality of features, a set of nodes of a multi-level knowledge graph of the plurality of multi-level knowledge graphs, wherein the set of nodes comprises one or more nodes found responsible for an issue reported in the plurality of previous tickets.

6. The computer-implemented method of claim 1, wherein the generating the weighted nested domain context corresponding to each of the plurality of instructor node embeddings comprises:
aggregating a plurality of nodes of a multi-level knowledge graph of a plurality of multi-level knowledge graphs to generate a set of instructor nodes, wherein the plurality of nodes is common across the plurality of features;
constructing a nested instructor node relationship across the plurality of features;
computing a nested instructor node relationship score for the constructed nested instructor node relationship; and
applying the nested instructor node relationship score as a weighted nested instructor score to all nodes of the set of instructor nodes.

7. The computer-implemented method of claim 1, wherein the generating the list of resolutions to solve the problem comprises generating the list of resolutions having the respective ranking of each prior record of the plurality of prior records that exceeds a specified threshold value.

8. A system comprising:
at least one memory comprising machine executable instructions; and
at least one processor communicatively coupled with the at least one memory and configured to execute the machine executable instructions to perform operations comprising:
generating a knowledge graph representation of a plurality of features extracted based on input data comprising one or more of a plurality of documents, email communication, and records stored in one or more data sources;
generating, based upon the knowledge graph representation, a plurality of instructor node embeddings and weighted nested domain context corresponding to each of the plurality of instructor node embeddings;
receiving, from a client device associated with a user, a query input, wherein the query input comprises description of a problem;
identifying, based on the plurality of instructor node embeddings and the weighted nested domain context corresponding to each of the plurality of instructor node embeddings, a plurality of prior records having semantic similarity with the query input; and
generating, based on a respective ranking of each prior record of the plurality of prior records, a list of resolutions to solve the problem identified in the query input.

9. The system of claim 8, wherein the generating the knowledge graph comprises:
performing data denoising and formatting of the input data to generate denoised and formatted input data;
generating or extracting, upon performing the data denoising and formatting, insights by deforming and extracting relevant insights from the denoised and formatted input data;
extracting, from each sentence of the relevant insights, a plurality of features, wherein each feature of the plurality of features represents a combination of an entity of a plurality of entities and a respective relationship of the entity with other entities of the plurality of entities; and
generating, for each feature of the plurality of features, a plurality of multi-level knowledge graphs for each ticket of a plurality of previous tickets.

10. The system of claim 9, wherein each entity of the plurality of entities represents a feature comprising one of: a manufacturer, a model, a country, a part or component, or a technology.

11. The system of claim 9, wherein the operations further comprising identifying, for a set of features of the plurality of features, a set of nodes of a multi-level knowledge graph of the plurality of multi-level knowledge graphs, wherein the set of nodes comprises one or more nodes connecting different entities.

12. The system of claim 9, wherein the operations further comprising identifying, for a set of features of the plurality of features, a set of nodes of a multi-level knowledge graph of the multi-level knowledge graphs, wherein the set of nodes comprises one or more nodes found responsible for an issue reported in the plurality of previous tickets.

13. The system of claim 8, wherein the generating the weighted nested domain context corresponding to each of the plurality of instructor node embeddings comprises:
aggregating a plurality of nodes of a multi-level knowledge graph of the multi-level knowledge graphs to generate a set of instructor nodes, wherein the plurality of nodes is common across the plurality of features;
constructing a nested instructor node relationship across the plurality of features;
computing a nested instructor node relationship score for the constructed nested instructor node relationship; and
applying the nested instructor node relationship score as a weighted nested instructor score to all nodes of the set of instructor nodes.

14. The system of claim 8, wherein the generating the list of resolutions to solve the problem comprises generating the list of resolutions having the respective ranking of each prior record of the plurality of prior records that exceeds a specified threshold value.

15. A non-transitory computer-readable medium (CRM) comprising machine executable instructions stored thereon, which, when executed by at least one processor of a computing device, cause the computing device to perform operations comprising:
generating a knowledge graph representation of a plurality of features extracted based on input data comprising one or more of a plurality of documents, email communication, and records stored in one or more data sources;
generating, based upon the knowledge graph representation, a plurality of instructor node embeddings and weighted nested domain context corresponding to each of the plurality of instructor node embeddings;
receiving, from a client device associated with a user, a query input, wherein the query input comprises description of a problem;
identifying, based on the plurality of instructor node embeddings and the weighted nested domain context corresponding to each of the plurality of instructor node embeddings, a plurality of prior records having semantic similarity with the query input; and
generating, based on a respective ranking of each prior record of the plurality of prior records, a list of resolutions to solve the problem identified in the query input.

16. The non-transitory CRM of claim 15, wherein the generating the knowledge graph comprises:
performing data denoising and formatting of the input data to generate denoised and formatted input data;
generating or extracting, upon performing the data denoising and formatting, insights by deforming and extracting relevant insights from the denoised and formatted input data;
extracting, from each sentence of the relevant insights, a plurality of features, wherein each feature of the plurality of features represents a combination of an entity of a plurality of entities and a respective relationship of the entity with other entities of the plurality of entities; and
generating, for each feature of the plurality of features, a plurality of multi-level knowledge graphs for each ticket of a plurality of previous tickets.

17. The non-transitory CRM of claim 16, wherein each entity of the plurality of entities represents a feature comprising one of: a manufacturer, a model, a country, a part or component, or a technology.

18. The non-transitory CRM of claim 16, wherein the operations further comprising identifying, for a set of features of the plurality of features, a set of nodes of a multi-level knowledge graph of the plurality of multi-level knowledge graphs, wherein the set of nodes comprises one or more nodes connecting different entities and/or responsible for an issue reported in the plurality of previous tickets.

19. The non-transitory CRM of claim 15, wherein the generating the weighted nested domain context corresponding to each of the plurality of instructor node embeddings comprises:
aggregating a plurality of nodes of a multi-level knowledge graph of the multi-level knowledge graphs to generate a set of instructor nodes, wherein the plurality of nodes is common across the plurality of features;
constructing a nested instructor node relationship across the plurality of features;
computing a nested instructor node relationship score for the constructed nested instructor node relationship; and
applying the nested instructor node relationship score as a weighted nested instructor score to all nodes of the set of instructor nodes.

20. The non-transitory CRM of claim 15, wherein the generating the list of resolutions to solve the problem comprises generating the list of resolutions having the respective ranking of each prior record of the plurality of prior records that exceeds a specified threshold value.
